(19) United States
(12) Patent Application Publication
(10) Pub. No.: US 2026/0091814 A1
(43) Pub. Date: Apr. 2, 2026

(54) PORTABLE SHOPPING CART CAPABLE OF SERVING AS SEAT

(71) Applicant: QINGDAO TMZ TOOLS CO., LTD., Qingdao City (CN)

(72) Inventor: Wei PANG, Qingdao City (CN)

(73) Assignee: QINGDAO TMZ TOOLS CO., LTD., Qingdao City (CN)

(21) Appl. No.: 18/904,774

(22) Filed: Oct. 2, 2024

(51) Int. Cl. B62B 1/00; B62B 1/12; B62B 5/06

(52) U.S. Cl. CPC B62B 1/008; B62B 5/06; B62B 1/12

(57) ABSTRACT

A portable shopping cart capable of serving as a seat includes a body part and a cloth pocket part. The body part is provided with a seat part. The body part includes a bottom supporting frame, a column supporting frame, a handle and wheels. A rotating positioning mechanism is arranged between the bottom supporting frame and the column supporting frame, and the rotating positioning mechanism is used for realizing rotation and support of the bottom supporting frame. The portable shopping cart realizes the functions of both a shopping cart and a seat, and can be transformed into a seat anytime and anywhere, and the handle can serve as the back of a chair, with high comfort. When not in use, the shopping cart can be folded for storage, so as to reduce the space of storage and transportation.

### TECHNICAL FIELD

The present invention belongs to the technical field of shopping carts, and particularly relates to a portable shopping cart capable of serving as a seat anytime and anywhere.

### BACKGROUND

In daily life, after people go shopping in a supermarket or a farmer's market, how to take home purchases is a very hard job, especially for the elderly, carrying heavy objects undoubtedly increases a heavy burden for them, so a portable shopping cart is certainly a good choice. In the process of walking and dragging heavy objects for a long time, people inevitably take a break. However, at present, the shopping cart on the market does not have the function of allowing people to rest as a seat, and the shopping cart is only used for dragging items. A portable seat on the market also only has the functions of the seat. The two are mainly independent individuals which have single functions, large occupied area and inconvenience of use.

In view of the above problems, the present invention provides a shopping cart capable of serving as a seat anytime and anywhere, which can be transformed into a seat to rest anytime and anywhere while dragging heavy objects.

### SUMMARY

In view of the defects of the prior art, the present invention provides a portable shopping cart capable of serving as a seat anytime and anywhere, which can be transformed into a seat to rest anytime and anywhere while dragging heavy objects by installing a seat part on a shopping cart body. Moreover, the shopping cart can be quickly folded, and the folded shopping cart has small occupied area, convenience of transportation and carrying, and beautiful overall appearance, thereby satisfying the needs of consumers.

To achieve the above purpose, the present invention is achieved through the following technical solution:

A portable shopping cart capable of serving as a seat comprises a body part and a cloth pocket part.

The body part is provided with a seat part.

The body part comprises a bottom supporting frame, a column supporting frame, a handle and wheels.

A rotating positioning mechanism is arranged between the bottom supporting frame and the column supporting frame, and the rotating positioning mechanism is used for realizing rotation and support of the bottom supporting frame.

Further, the rotating positioning mechanism comprises positioning parts and a rotating part, the positioning parts are fixed to the bottom of the column supporting frame, and the rotating part is fixed to one end of the bottom supporting frame.

Further, the positioning parts are two positioning columns arranged up and down; the rotating part is a rotating supporting control piece; the rotating supporting control piece is provided with a strip-shaped hole and a special-shaped track notch; the strip-shaped hole is adapted to the lower positioning column; and the special-shaped track notch is adapted to the upper positioning column.

Further, the special-shaped track notch is a T-shaped opening, and an internal hook part is arranged at the opening so that the positioning column is not easy to come out.

Further, end parts of the positioning columns are provided with bulges.

Further, the handle is a handle that can adjust a rotation angle in multiple gears. When there is a need for rest, the handle is rotated and tilted to a suitable position. At this moment, the handle can serve as the back of a chair.

Further, the seat part is a rectangular frame structure and is fixedly connected to an upper part of the column supporting frame.

Further, the bottom supporting frame is a rectangular frame structure, and comprises a transverse brace and a vertical brace; the bottom of one end is provided with two supporting legs; the supporting legs adopt supporting legs individually and fixedly welded on the vertical brace of the bottom supporting frame; or an end part of the vertical brace of the bottom supporting frame is bent to form the supporting legs; or individual plastic pieces are adopted as the supporting legs. The entire shopping cart is supported by four supporting legs when standing: the four supporting legs are two columns of the column supporting frame and two supporting legs arranged at one end of the bottom supporting frame respectively.

Further, the column supporting frame comprises two columns, and the transverse brace is arranged between the two columns. The transverse brace not only increases the strength, but also is used for auxiliary operation of the folding of the bottom supporting frame.

Further, the cloth pocket part is directly placed on the bottom supporting frame, and fixed to a body on both sides and the bottom by tear fasteners, and the cloth pocket part is also provided with a soft cushion adapted to the seat part to increase the degree of comfort.

Specifically, in the process of use:

In an initial state, when the body is in a folded state, the handle is rotated to the same extension plane as the column supporting frame. Then, the bottom supporting frame is expanded. At this moment, the rotating supporting control piece rotates around the lower positioning column. Meanwhile, the upper positioning column enters the special-shaped track notch of the rotating supporting control piece, and then the bottom supporting frame is pressed down. The upper positioning column enters the special-shaped track notch to achieve the positioning. At this moment, the bottom supporting frame is firmly supported on the ground.

When the body needs to be folded, one end of the bottom supporting frame near the column supporting frame is lifted up. At this moment, the upper positioning column is separated from the special-shaped track notch, and then the bottom supporting frame can be rotated around the lower positioning column and folded. The bottom supporting frame is fixed to the column supporting frame by tear fasteners. Then, the handle is rotated and folded.

When there is a need for rest in walking and dragging heavy objects, the handle is regulated and inclined to a comfortable position to sit on the seat part to rest, and the back can lean on the handle.

Compared with the prior art, the present invention has the following advantages and positive effects:
(1) The portable shopping cart of the present invention realizes the functions of both a shopping cart and a seat, and can be transformed into a seat anytime and anywhere, and the handle can serve as the back of a chair, with high comfort.
(2) When not in use, the shopping cart can be folded for storage, so as to reduce the space of storage and transportation. The rotating positioning mechanism of the bottom supporting frame is ingenious in design, novel in conception and convenient in operation.

In conclusion, the portable shopping cart of the present invention has multiple uses. Thus, consumers can enjoy the functionality of shopping and the seat with the cost of a single cart, so that the performance price ratio is very high and conservation and environmental protection can be realized.

After the detailed description of the embodiments of the present invention is read in combination with the drawings, other features and advantages of the present invention will become clearer.

### DESCRIPTION OF DRAWINGS

The present invention will be further described below in combination with drawings and embodiments. In the figures:

FIG. 1 is an integral structural schematic diagram of a specific embodiment of a portable shopping cart capable of serving as a seat in the present invention;

FIG. 2 is an integral structural schematic diagram of a specific embodiment of a portable shopping cart capable of serving as a seat in the present invention (the cloth pocket is removed);

FIG. 3 is a reference diagram of a specific use state that a portable shopping cart capable of serving as a seat in a specific embodiment is used as a seat in the present invention;

FIG. 4 is a structural schematic diagram after a portable shopping cart capable of serving as a seat in a specific embodiment is completely folded in the present invention;

FIG. 5 is a structural schematic diagram of a rotating positioning mechanism;

FIG. 6 is a local enlarged view of position A in FIG. 2;

FIG. 7 is a local enlarged view of position B in FIG. 4;

### NUMERALS IN THE FIGURES AND DESCRIPTION

100 body part; 101 seat part; 102 bottom supporting frame; 103 column supporting frame; 104 handle; 105 wheel; 106 upper positioning column; 107 lower positioning column; 108 rotating supporting control piece; 109 strip-shaped hole; 110 special-shaped track notch; 111 internal hook part; 112 column; 113 transverse brace; 114 transverse brace; 115 vertical brace; 116 supporting leg; 200 cloth pocket part; 201 tear fastener; 202 soft cushion.

### DETAILED DESCRIPTION

To make the purpose, the technical solution and the advantages of the present invention more clear, the present invention will be further described below in detail in combination with the drawings and the embodiments. It should be understood that the embodiments described herein are only used for explaining the present invention, not used for limiting the present invention.

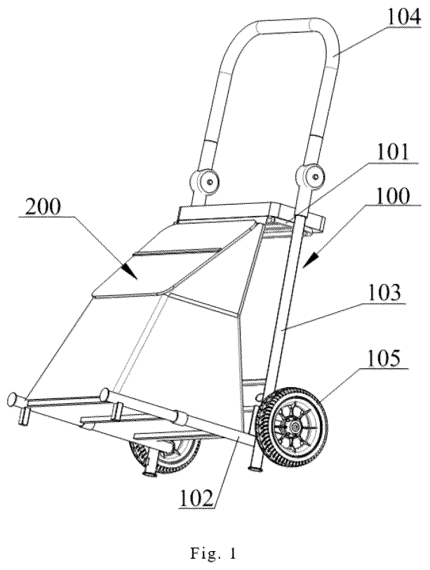

FIGS. 1-4 show a specific embodiment of a portable shopping cart capable of serving as a seat in the present invention, comprising a body part 100 and a cloth pocket part 200. The body part 100 is provided with a seat part 101.

Wherein the body part 100 comprises a bottom supporting frame 102, a column supporting frame 103, a handle 104 and wheels 105; a rotating positioning mechanism is arranged between the bottom supporting frame 102 and the column supporting frame 103, and the rotating positioning mechanism is used for realizing rotation and support of the bottom supporting frame.

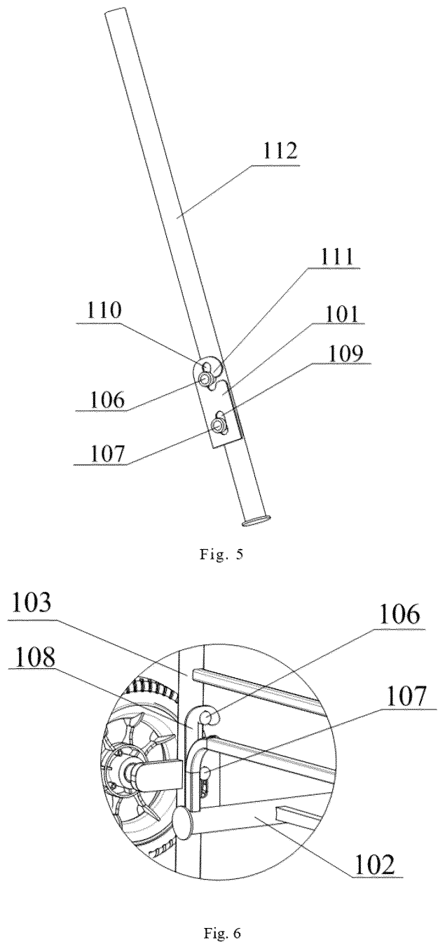

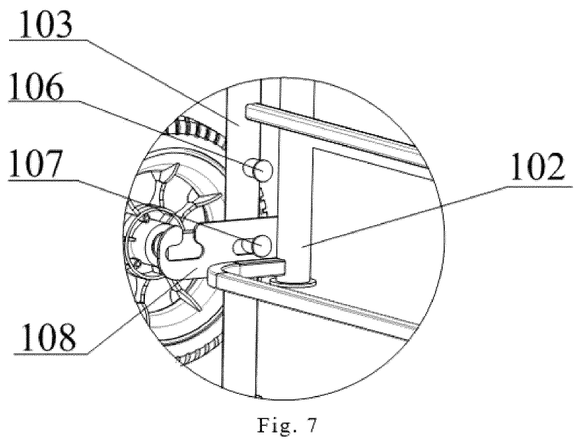

Specifically, as shown in FIGS. 5-7, the rotating positioning mechanism comprises positioning parts and a rotating part; the positioning parts are two positioning columns 106 and 107 which are arranged up and down and fixed to the bottom of the column supporting frame 103; and end parts of the positioning columns 106 and 107 are provided with bulges. The rotating part is a rotating supporting control piece 108 and is fixed to one end of the bottom supporting frame 102; the rotating supporting control piece 108 is provided with a strip-shaped hole 109 and a special-shaped track notch 110; the strip-shaped hole 109 is adapted to the lower positioning column 107; and the special-shaped track notch 110 is adapted to the upper positioning column 106. The special-shaped track notch 110 is a T-shaped opening, and an internal hook part 111 is arranged at the opening so that the positioning column 106 is not easy to come out. The rotating positioning mechanism of the shopping cart is ingenious in design, novel in conception and convenient in operation.

The handle 104 is a handle that can adjust a rotation angle in multiple gears. The seat part 101 is fixedly connected to the upper part of the column supporting frame 103. The seat part 101 is a rectangular frame structure. When there is a need for rest, the handle 104 is rotated and tilted to a suitable position. At this moment, the handle can serve as the back of a chair.

The column supporting frame 103 comprises two columns 112, and the transverse brace 113 is arranged between the two columns. The transverse brace increases the strength, and is also used for auxiliary operation of the folding of the bottom supporting frame 102. The bottom supporting frame 102 is a rectangular frame structure, and comprises a transverse brace 114 and a vertical brace 115; and two supporting legs 116 are welded and fixed on the bottom of one end. The entire shopping cart is supported by four supporting legs when standing: the four supporting legs are two columns 112 of the column supporting frame 103 and two supporting legs 116 arranged at one end of the bottom supporting frame respectively. Of course, the structures of the above supporting legs 116 do not limit the welding and fixing structure of the embodiment, and an end part of the vertical brace 115 of the bottom supporting frame 102 can also be bent to form the supporting legs; or individual plastic pieces can also be adopted as the supporting legs.

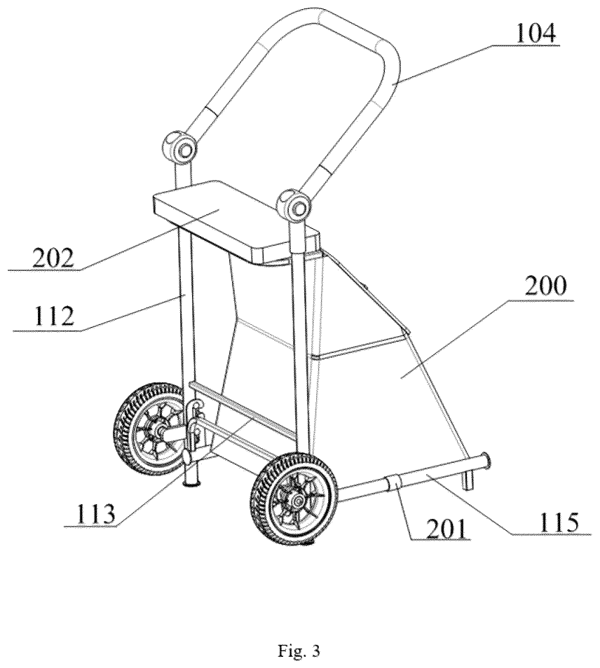

The cloth pocket part 200 can be directly placed on the bottom supporting frame 102, and fixed to a body on both sides and the bottom by tear fasteners 201, and the cloth pocket part 200 is also provided with a soft cushion 202 adapted to the seat part 101 to increase the degree of comfort, as shown in FIG. 3.

A specific use method of the shopping cart in the above embodiment:

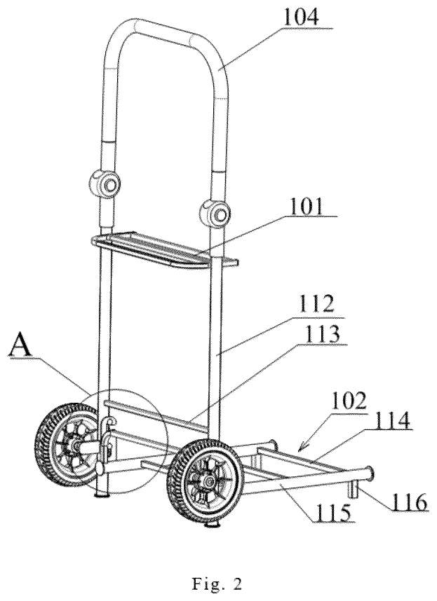

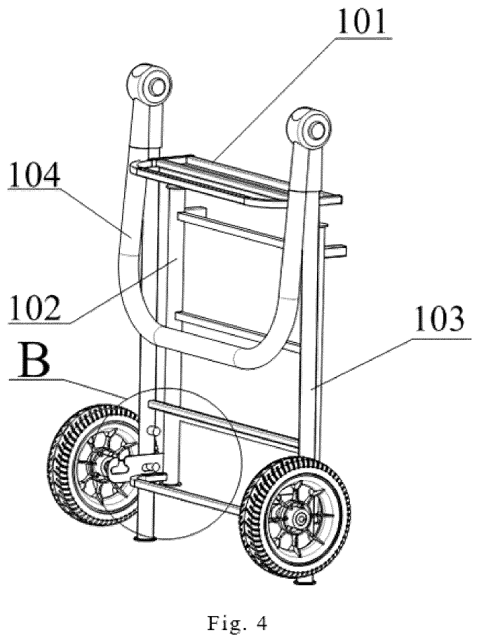

In an initial state, as shown in FIG. 4, when the body part 100 is in a folded state, the handle 104 is rotated to the same extension plane as the column supporting frame 103. Then, the bottom supporting frame 102 is expanded. At this moment, the rotating supporting control piece 108 rotates around the lower positioning column 107. Meanwhile, the upper positioning column 106 enters the special-shaped track notch 110 of the rotating supporting control piece, and then the bottom supporting frame 102 is pressed down. The upper positioning column 106 enters the special-shaped track notch 110 to achieve the positioning. At this moment, the bottom supporting frame 102 is firmly supported on the ground, as shown in FIG. 2.

When the shopping cart needs to be folded, one end of the bottom supporting frame 102 near the column supporting frame 103 is lifted up. At this moment, the upper positioning column 106 is separated from the special-shaped track notch 110, and then the bottom supporting frame 102 can be rotated around the lower positioning column 107 and folded. The bottom supporting frame is fixed to the column supporting frame 103 by tear fasteners. Then, the handle 104 is rotated and folded.

When there is a need for rest in walking and dragging heavy objects, the handle 104 is regulated and inclined to a comfortable position to sit on the seat part 101 to rest, and the back can lean on the handle 104, as shown in FIG. 3.

The portable shopping cart of the present invention realizes the functions of both a shopping cart and a seat, and can be transformed into a seat to rest anytime and anywhere, and the handle can serve as the back of a chair, with high comfort. When not in use, the shopping cart can be folded for storage, so as to reduce the space of storage and transportation. The portable shopping cart of the present invention has multiple purposes, is practical and beautiful, and satisfies the needs of the increasingly rich leisure life habits of people.

Finally, it should be noted that the above embodiments are only used for describing the technical solution of the present invention rather than limitation. Although the present invention is described in detail by referring to the above embodiments, those ordinary skilled in the art should understand that the technical solution recorded in each of the above embodiments can be still amended, or some technical features therein can be replaced equivalently. However, these amendments or replacements do not enable the essence of the corresponding technical solution to depart from the spirit and the scope of the technical solution of various embodiments of the present invention.

1. A portable shopping cart capable of serving as a seat, comprising a body part and a cloth pocket part, wherein:
the body part is provided with a seat part;
the body part comprises a bottom supporting frame, a column supporting frame, a handle and wheels;
a rotating positioning mechanism is arranged between the bottom supporting frame and the column supporting frame, and the rotating positioning mechanism is used for realizing rotation and support of the bottom supporting frame.

2. The portable shopping cart capable of serving as a seat according to claim 1, wherein the rotating positioning mechanism comprises positioning parts and a rotating part, the positioning parts are fixed to the bottom of the column supporting frame, and the rotating part is fixed to one end of the bottom supporting frame.

3. The portable shopping cart capable of serving as a seat according to claim 2, wherein the positioning parts are two positioning columns arranged up and down; the rotating part is a rotating supporting control piece; the rotating supporting control piece is provided with a strip-shaped hole and a special-shaped track notch; the strip-shaped hole is adapted to the lower positioning column; and the special-shaped track notch is adapted to the upper positioning column.

4. The portable shopping cart capable of serving as a seat according to claim 3, wherein
the special-shaped track notch is a T-shaped opening, and an internal hook part is arranged at the opening.

5. The portable shopping cart capable of serving as a seat according to claim 3, wherein end parts of the positioning columns are provided with bulges.

6. The portable shopping cart capable of serving as a seat according to claim 1, wherein
the handle is a handle that can adjust a rotation angle in multiple gears.

7. The portable shopping cart capable of serving as a seat according to claim 1, wherein
the seat part is a rectangular frame structure and is fixedly connected to an upper part of the column supporting frame.

8. The portable shopping cart capable of serving as a seat according to claim 1, wherein
the bottom supporting frame is a rectangular frame structure, and comprises a transverse brace and a vertical brace; the bottom of one end is provided with two supporting legs; the supporting legs adopt supporting legs individually and fixedly welded on the vertical brace of the bottom supporting frame; or an end part of the vertical brace of the bottom supporting frame is bent to form the supporting legs; or individual plastic pieces are adopted as the supporting legs.

9. The portable shopping cart capable of serving as a seat according to claim 1, wherein
the column supporting frame comprises two columns, and the transverse brace is arranged between the two columns.

10. The portable shopping cart capable of serving as a seat according to claim 1, wherein the cloth pocket part is directly placed on the bottom supporting frame, and fixed to a body on both sides and the bottom by tear fasteners, and the cloth pocket part is also provided with a soft cushion adapted to the seat part.
